(19) United States
(12) Patent Application Publication
(10) Pub. No.: US 2005/0094949 A1
(43) Pub. Date: May 5, 2005

(54) Hermetically sealed package for an electro-optic device

(76) Inventor: Jan Mink, Geldrop (NL)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/982,489

(22) Filed: Nov. 5, 2004

Related U.S. Application Data
(62) Division of application No. 10/694,256, filed on Oct. 27, 2003.
(60) Provisional application No. 60/421,440, filed on Oct. 25, 2002.

(51) Int. Cl. G02B 6/36

(52) U.S. Cl. 385/92; 385/88; 385/93; 385/94; 385/15; 385/31; 385/33

(57) ABSTRACT

This disclosure is concerned with optical packages. In one example, a package for an optical device includes a substrate that supports an optical device. A window of the package covers the portion of the substrate that supports the optical device. Additionally, the window forms a hermetic seal for the supported optical device.

### RELATED APPLICATIONS

This application is a division, and claims the benefit, of U.S. patent application Ser. No. 10/694,256, entitled HERMETICALLY SEALED PACKAGE FOR AN ELECTRO-OPTIC DEVICE, filed Oct. 27, 2003 which, in turn, claims the benefit of U.S. Provisional Patent Application Ser. No. 60/421,440, filed on Oct. 25, 2002. All of the aforementioned patent applications are incorporated herein in their respective entireties by this reference.

### BACKGROUND OF THE INVENTION

1. Field of the Invention

The present invention relates generally to packaging optical components. More particularly, the invention relates to hermetically sealed packages for electro-optic devices, including semiconductor optical amplifiers.

2. Related Technology

As the demand for applications that allow for delivery of multimedia files, video, voice over IP, gaming and other types of data and/or information over the Internet (or other networks) continues to increase, the demand for communications bandwidth will also increase. Fiber optics will play an important role in supplying the increased bandwidth to meet these ever increasing demands. As a result, there will also be an ever increasing demand for electro-optic devices such as electrically pumped optical amplifiers, photodetectors, lasers and other optical sources, modulators, etc., that are smaller and cheaper to produce.

To improve reliability, electro-optic devices are often packaged in a manner that creates a hermetic seal around the device. Hermetic sealing prevents gasses and liquids from entering the sealed area and corroding or otherwise interfering with the operation of the device. In addition to hermetic seals, electro-optic devices may also require a heat sink to properly dissipate the heat created by the electro-optic device during its operation.

The metal butterfly package is a package that is commonly used to provide hermetic sealing devices. In this approach, optical signals typically enter and/or exit the electro-optic device via fiber pigtails. The device is positioned inside an open butterfly package, and the fiber optic pigtails are aligned to the device, also inside the butterfly package. The entire metal butterfly package is sealed with a metal top. In addition, the locations where the fiber pigtails pierce the butterfly package are specially sealed to ensure that the entire butterfly package is hermetically sealed. In this approach, the device and portions of the pigtails (and often also including auxiliary components such as coupling lenses) are all contained inside the butterfly package. The butterfly package hermetically seals all of these components. In one configuration, the butterfly package is mounted directly to a heat sink such as a thermoelectric (or peltier) cooler to carry heat away from the electro-optic device mounted in the butterfly package.

One problem with the butterfly package and similar approaches are their inherently large size when compared to the electro-optic device enclosed in the package. Often, the electro-optic device is a semiconductor-based structure that is very small in size. For example, the electro-optic device may be a semiconductor optical amplifier, photodetector, or semiconductor laser. The hermetically sealed area around the electro-optic device is much larger in the butterfly package than is needed to seal just the device. In fact, the butterfly package typically hermetically seals a large number of components besides just the device—a portion of the fiber pigtails and auxiliary lenses, for example.

Butterfly packages are also relatively expensive. They are typically made of a gold alloy. In addition, as mentioned above, the locations where the fiber pigtails enter and exit the butterfly package must be specially sealed to ensure the entire package has a hermetic seal. This can be a difficult process and further increases the overall cost of the package, as well as reducing long-term reliability. The cost of the package becomes especially important as device technology progresses since the cost of the device typically decreases dramatically, meaning that the cost of the package will account for a greater fraction of the overall cost.

Thus, there is a need for a package for electro-optic devices that hermetically seals the electro-optic device and is smaller and more cost effective than the butterfly package. It would also be beneficial if these packages could be used with heat sinks.

### BRIEF SUMMARY OF AN EXEMPLARY EMBODIMENT OF THE INVENTION

The present invention is directed to a package for optical devices such as an electro-optic device that creates a hermetic seal around the enclosed device. In one embodiment, a package for an electro-optic device includes a substrate for supporting the device, and a cap enclosing the device and a portion of the substrate. The cap creates a hermetic seal around the device and includes two windows to permit coupling of optical signals to and from the device. The device can be a semiconductor optical amplifier (SOA) or other two port optical device. An optical signal enters the cap through one of the windows and is amplified by the SOA. The amplified optical signal exits the cap through the second window. Lenses can be positioned on both sides of the cap. The lens on the input side of the cap receives the optical signal from an input optical fiber and couples the optical signal to an optical port of the SOA. The lens on the output side of the cap couples the amplified optical signal into an output optical fiber. The substrate and cap can be enclosed in a housing made of plastic or other inexpensive material to protect the optical components.

In another embodiment of the present invention, the substrate is mounted to the cool plate of a thermo-electric or peltier cooler. The thermo-electric cooler dissipates heat generated by the optical device and other optical components located on the substrate. In an alternative embodiment, the substrate is comprised of ceramic and is used as both the cool plate on the thermo-electric cooler and a mounting platform for the optical device and the other optical components.

In a further embodiment of the invention, a package for an optical device includes a substrate having a top surface and a recessed area, and an optical device mounted in the recessed area. A window covering the recessed area forms a hermetic seal for the optical device. Reflective devices can be employed for redirecting an optical signal between an optical path located along the top surface of the substrate and L-the optical device mounted in the recessed area. In one embodiment, a semiconductor optical amplifier or other two port optical device is positioned in the recessed area to amplify the optical signal. The amplified optical signal is redirected out of the recessed area of the substrate and then redirected to propagate above the substrate. In another embodiment, a photodetector or other one port optical device is positioned in the recessed area. In this embodiment, a portion of the optical signal is tapped as the optical signal propagates above the substrate and is redirected into the recessed area of the substrate. The tapped portion of the optical signal is detected by the photodetector to monitor the signal strength of the optical signal.

The present invention is advantageous because hermetically sealing an optical device such as an SOA using a metal cap is much less expensive than sealing the SOA using a metal butterfly package or similar conventional package. In addition, the package of the present invention is smaller and less expensive than conventional packages since the hermetically sealed area is smaller. Further, the SOA is hermetically sealed early in the manufacturing process. This results in a cleaner seal around the SOA and protects the SOA during the remainder of the manufacturing process. The present invention is not limited to protecting a SOA and can be used to package other electro-optic devices.

These and other aspects of the present invention will become more fully apparent from the following description and appended claims.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a substrate with various components mounted to the substrate;

FIGS. 2A-2B are a perspective and a front exploded view illustrating a semiconductor optical amplifier (SOA) mounted to a substrate and enclosed by a cap;

FIG. 3 is a detailed top view of a mounting plate;

FIGS. 4A-4D are various views of a bottom portion of a housing;

FIGS. 5A-5B are perspective views of a lid for the bottom portion of FIG. 4A;

FIG. 6A is a side view of a substrate mounted to a thermoelectric cooler;

FIG. 6B is a side view of a thermoelectric cooler with a ceramic substrate functioning as both the top plate of the thermoelectric cooler and a mounting platform for an optical device;

FIGS. 7A-7B are side cross-sectional views of optical devices positioned in a recessed area of a substrate; and

FIG. 8 is a side cross-sectional view of an optical device positioned in a recessed area of a multi-layer substrate.

### DETAILED DESCRIPTION OF EXEMPLARY EMBODIMENTS OF THE INVENTION

The present invention is directed to hermetically sealed packages for electro-optic devices such as semiconductor optical amplifiers. Reference will now be made to the drawings to describe various embodiments of the invention. It is to be understood that the drawings are diagrammatic and schematic representations of the embodiments, and are not limiting of the present invention, nor are they necessarily drawn to scale.

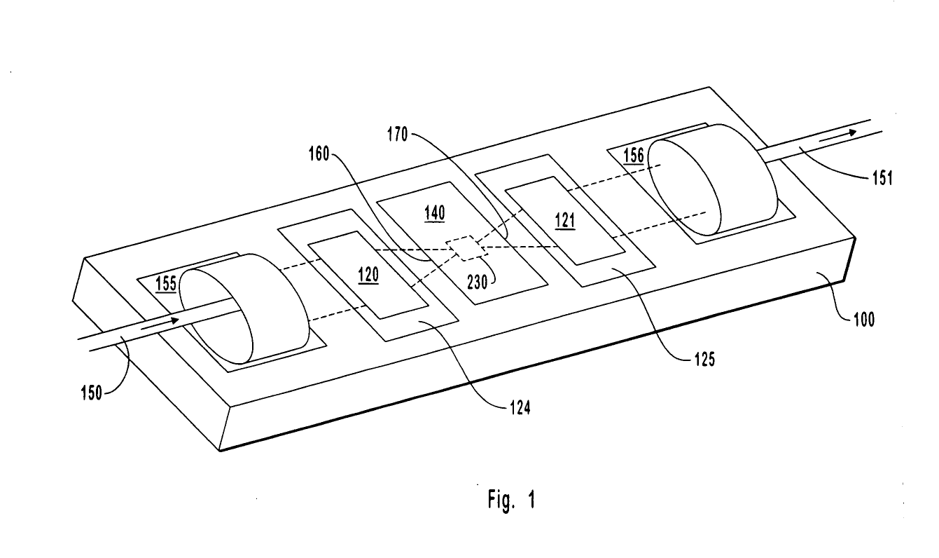

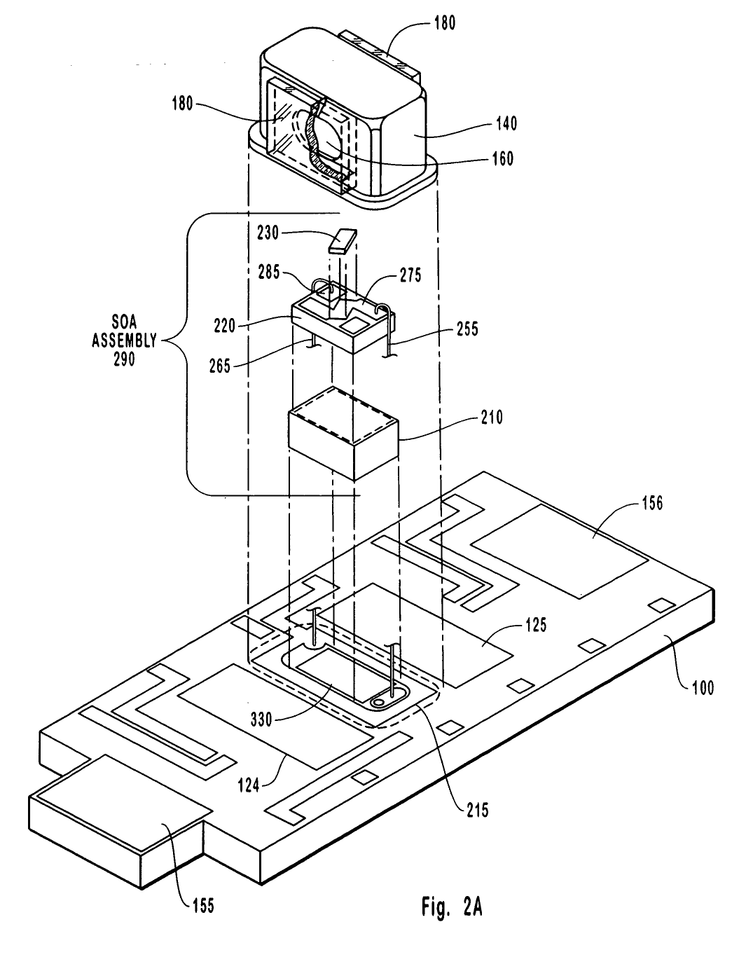

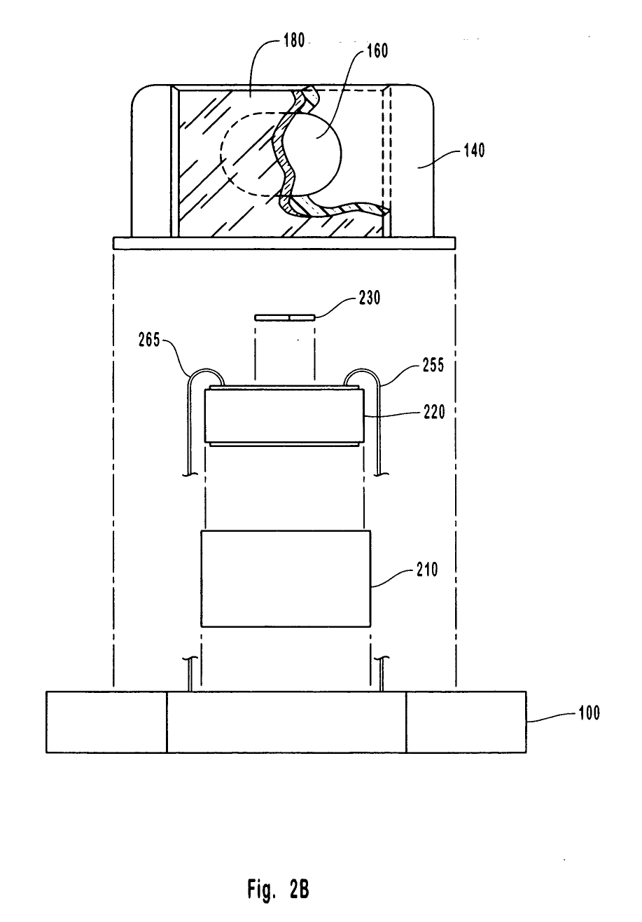

FIG. 1 illustrates the interior of one embodiment of a package for a semiconductor optical amplifier (SOA) 230 according to the present invention. In this embodiment, optical fibers 150 and 151 are mounted to a substrate 100 on mounting plates 155 and 156, respectively. Lenses 120 and 121 are mounted to substrate 100 on mounting plates 124 and 125. Cap 140 is mounted to substrate 100 via a mounting plate (not shown) and provides a hermetic seal around SOA 230 (as shown in FIG. 2). Cap 140 has two windows 160 and 170. The windows 160 and 170 are positioned so that optical signals may be optically coupled to/from the SOA 230.

In the package of FIG. 1, the hermetically sealed device is an SOA that operates to amplify an optical signal. An optical signal is received through optical fiber 150. The optical signal passes to lens 120 that directs the optical signal into cap 140 through window 160. Lens 120 is configured to couple the optical signal from fiber 150 into an input optical port of the SOA (e.g., the active region of the SOA). The optical signal is amplified as it propagates through the active region of the SOA and the amplified optical signal exits the SOA via its output optical port. The optical signal then exits cap 140 through window 170. Lens 121 receives the amplified optical signal exiting the cap 140 and couples the optical signal into optical fiber 151. The optical signal exits the package through optical fiber 151.

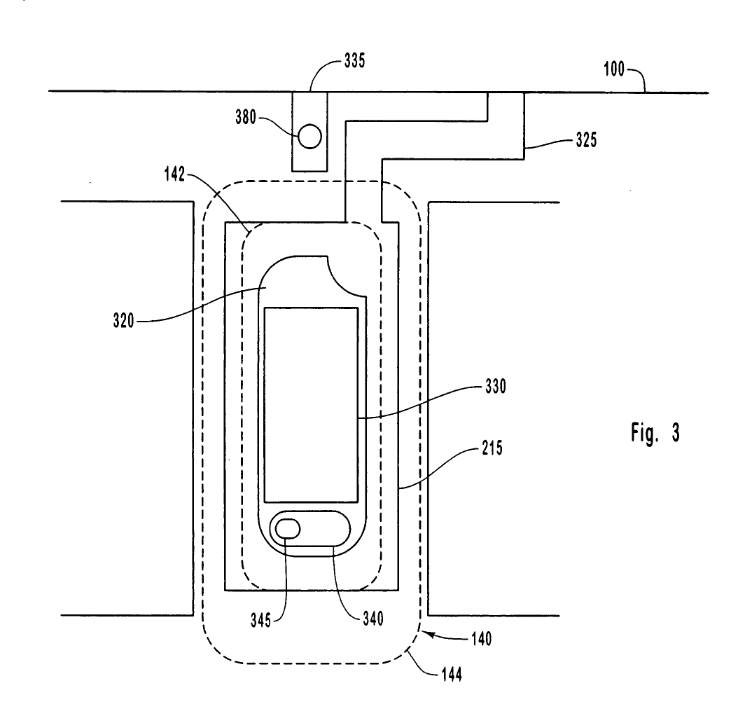

FIGS. 2A-2B are exploded views illustrating how SOA 230 and cap 140 are mounted to substrate 100. In this embodiment, the SOA 230 and cap 140 are mounted to mounting plate 215, which is mounted to substrate 100. In an alternative embodiment, the cap 140 may be mounted directly to substrate 100. FIGS. 2A-2B will be further described in conjunction with FIG. 3, which illustrates mounting plate 215 in greater detail.

In the embodiment of FIG. 2A, SOA 230 is not directly mounted to substrate 100. The SOA 230 is mounted to submount 220 that has metal leads 275 and 285 for providing the electrical connections to the electrical ports of SOA 230. In a preferred embodiment, SOA 230 is mounted to submount 220 so that the faces of SOA 230 are not perfectly perpendicular to the incoming and outgoing optical signals. When light is directed at SOA 230, some of the light will be reflected from the face of SOA 230. By angling this face with respect to the incoming optical signal, the reflected light is directed away from the input path of the optical signal. This prevents the reflected light from substantially interfering with the input optical signal. A similar situation occurs at the exit of SOA 230. For the same reason, the optical path within the SOA 230 itself preferably is also not perfectly perpendicular to the SOA faces.

Submount 220 is mounted to the top of spacer block 210. In one, embodiment, submount 220 and spacer block 210 are made from a ceramic material. However, other materials can be used. The combination of spacer block 210, submount 220, and SOA 230 will be referred to as the SOA assembly 290. The SOA assembly 290 is mounted to plate 330, as illustrated in greater detail in FIG. 3. Note that plate 330 is electrically isolated from mounting plate 215 by non-conducting layer 320.

Mounting plate 215 is connected to a metal lead 325 to provide one of the electrical contacts to submount 220. As illustrated, a metal wire 265 couples mounting plate 215 to metal lead 285 of submount 220. The second electrical contact for submount 220 comes from a contact area 340, which is isolated from mounting plate 215 by non-conducting layer 320. A metal wire 255 couples contact area 340 to metal lead 275 of submount 220. As mentioned previously, metal leads 275 and 285 provide the electrical connections needed to operate SOA 230. These electrical connections are not shown in the figures but can be made by coupling wires from metal leads 275 and 285 to SOA 230.

A metal lead 335, located at the edge of substrate 100, provides the electrical connection to contact area 340. However, as illustrated in FIG. 3, contact area 340 does not overlap with metal lead 335. To electrically couple the two, a via hole 345 is made in substrate 100 extending from contact area 340 to the bottom of substrate 100. Similarly, a via hole 380 is made extending from metal lead 335 to the bottom of substrate 100. The two via holes 345 and 380 are electrically coupled on the bottom of substrate 100. In one embodiment, a metal mounting plate is positioned on the bottom of substrate 100 that electrically couples the two via holes while at the same time providing a metal surface for mounting substrate 100 to another surface. In another embodiment, substrate 100 is a multilayer ceramic substrate. In this embodiment, the via holes 380 and 345 extend to one of the middle layers of substrate 100 where a strip of metal provides the electrical connection between the two via holes.

Returning to FIGS. 2A-2B, cap 140 is positioned over SOA assembly 290 and mounted to mounting plate 215. The inside and outside edges 142, 144 of cap 140 are outlined in relation to mounting plate 215 in FIG. 3. In a preferred embodiment, cap 140 is welded to mounting plate 215 to provide a hermetic seal around SOA 230. In one embodiment, cap 140 is made from a conducting metal, such as gold. However, other metals can be used. In this example, since the cap 140 overlaps with lead 325, it makes electrical contact with lead 325.

Cap 140 has two windows 160 and 170. In this example, the windows 160 and 170 are located on opposite sides of cap 140. Windows 160 and 170 allow optical signals to enter and exit cap 140, respectively. Windows 160 and 170 are formed by making cut-outs in the metal of cap 140 and securing transparent plates 180 to hermetically seal windows 160 and 170. In one embodiment, the transparent plates 180 are made of glass.

In another embodiment of the invention, the transparent plates 180 are lenses that direct the optical signal entering and exiting cap 140. The lens of window 160 is designed to couple incoming optical signals into SOA 230, while the lens of window 170 is designed to couple optical signals exiting SOA 230 into an optical fiber located outside of cap 140. In this embodiment, the lenses that are mounted to mounting plates 124 and 125 of substrate 100 are replaced with (or are augmented by) the lenses that are integrated with windows 160 and 170. This further reduces the size of the overall package for SOA 230.

The choice of materials and mounting/assembly techniques will depend on the application, which in turn will depend in part on the wavelength of the optical signal to be amplified. Wavelengths in the approximately 1.3-1.6 micron region are currently preferred for telecommunications applications, due to the spectral properties of optical fibers. The approximately 1.28-1.35 micron region is currently also preferred for data communications over a single mode fiber, with the approximately 0.8-1.1 micron region being an alternate wavelength region. Terms such as “optical,” “light,” “transparent,” etc. are meant to include all of these wavelength regions.

Materials selection and construction of the various components described above can be achieved using conventional techniques. Mounting and assembly can also be achieved using conventional techniques, including but not limited to welding, soldering, gluing, etc.

Hermetically sealing SOA 230 with cap 140 provides many advantages over conventional approaches such as the butterfly package. For example, SOA 230, submount 220, and spacer block 210 can be mounted to substrate 100 and hermetically sealed with cap 140 early in the manufacturing process. This results in a cleaner seal around SOA 230 and protects SOA 230 for the remainder of the manufacturing process. This improves the reliability of the SOA device.

In addition, hermetically sealing just the electro-optic device with cap 140 substantially reduces the size of the package for the electro-optic device and also substantially reduces the cost of manufacturing. As described above, in conventional packaging, the substrate 100 and all of the components mounted on the substrate are hermetically sealed in a butterfly package or similar package. Butterfly packages are made of metal, typically gold and are a relatively expensive part of the manufacturing process. The present invention reduces the cost of manufacturing by eliminating the need for the expensive butterfly package. Since the individual component is hermetically sealed using a small metal cap, the substrate and other components can be mounted in a housing made of a cheaper material such as plastic, as described herein. In addition, the manufacturing process is simplified since the areas around the fiber pigtails no longer need to be hermetically sealed as they do when using a butterfly package.

Finally, using cap 140 to seal the electro-optic device reduces the size of the final package as compared to a butterfly package. The butterfly package creates a hermetically sealed area around portions of the substrate that do not need to be hermetically sealed. Cap 140 hermetically seals a smaller area of substrate 100, which allows the remainder of substrate 100 to be covered by a housing made of plastic or other material that can be specially shaped to minimize the overall size of the package depending on the application.

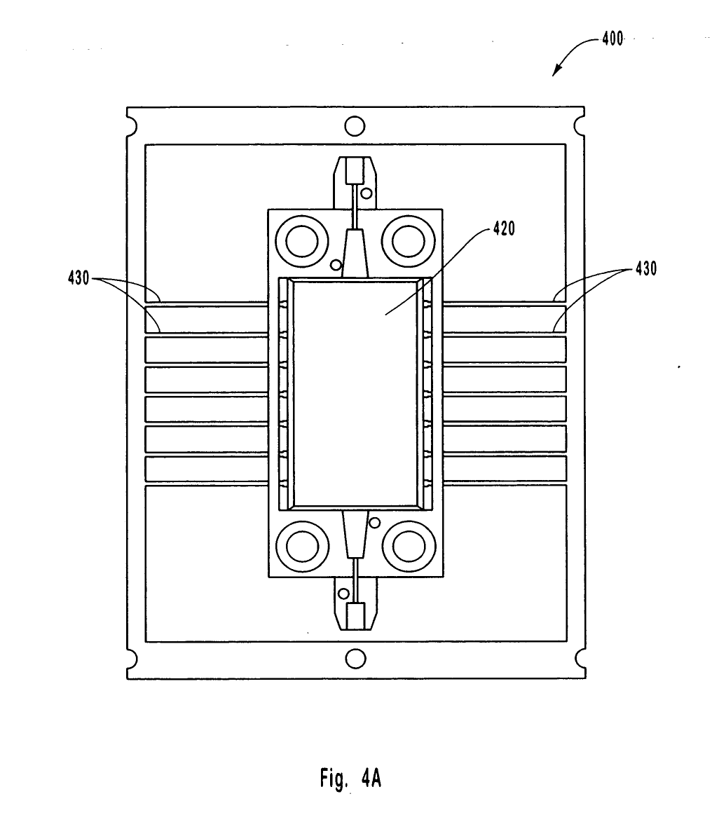

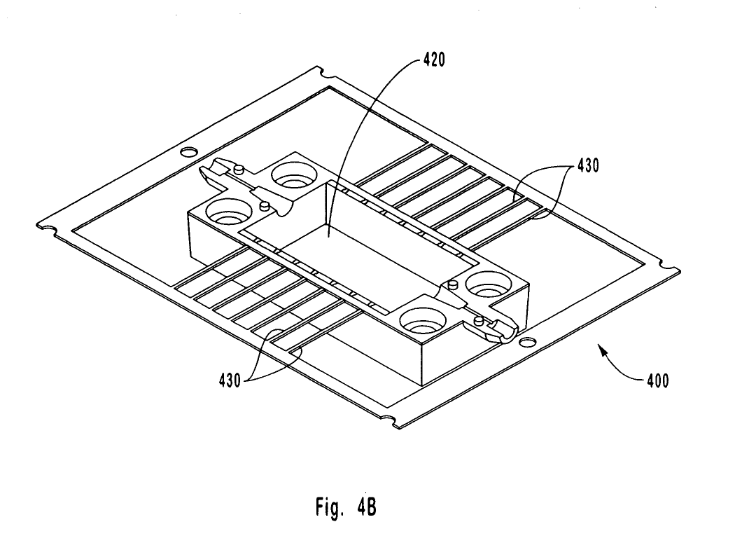

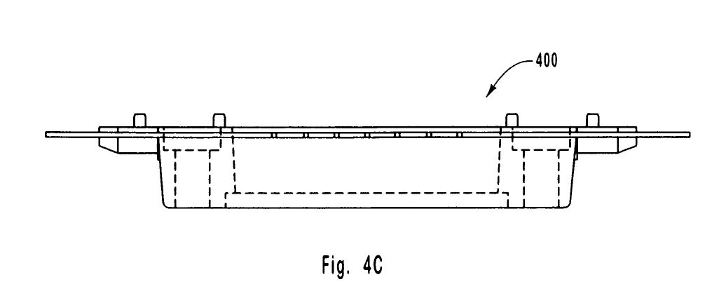

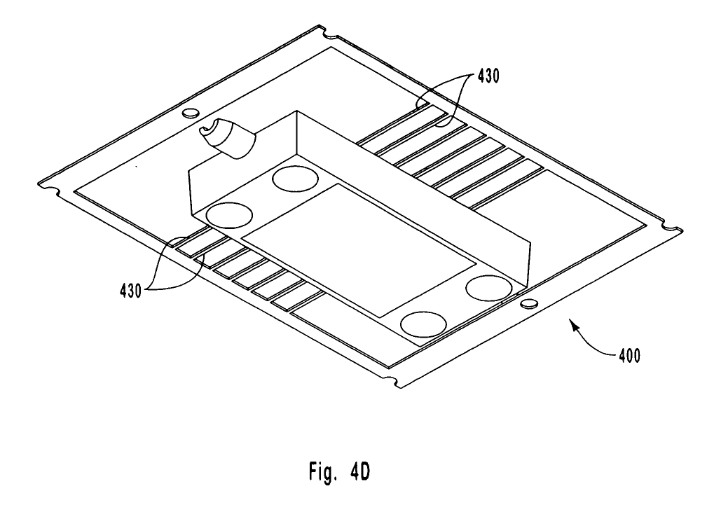

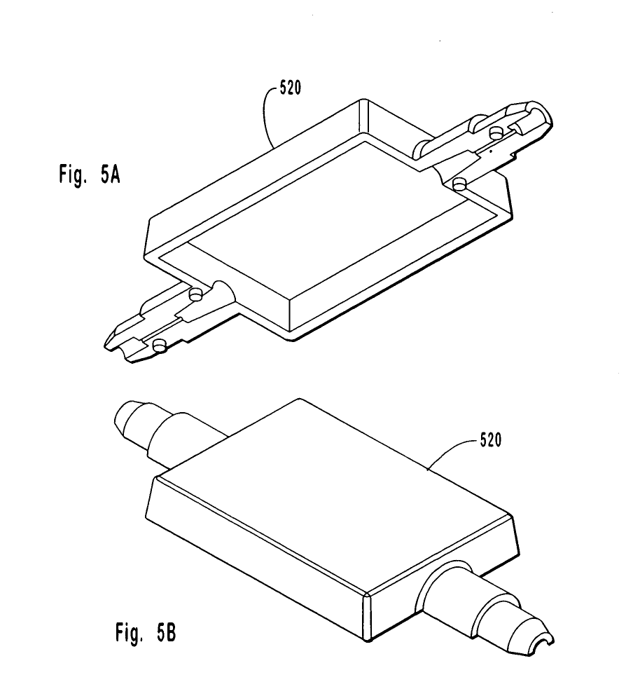

FIGS. 4A-4D illustrate a top view, top perspective view, side view and bottom perspective view, respectively, of the bottom portion 400 of an example housing that can be used to package substrate 100. In these figures, the bottom portion 400 is shown still attached to its lead frame. FIGS. 5A-5B illustrate a top perspective and bottom perspective view, respectively, of a lid 520 for the housing. As described previously, the housing does not need to create a hermetic seal around the entire substrate 100 or all of the components mounted on the substrate, since SOA 230 is hermetically sealed by cap 140. Thus, the housing can be made from plastic or other materials that cost much less than the metal butterfly package.

As illustrated in FIGS. 4A-4C, the housing has a cavity 420. Substrate 100 is positioned in the cavity 420 and metal leads 430 of the housing are electrically coupled to the corresponding metal leads on substrate 100. In addition, the housing has special indentations at both ends of the housing for receiving the fiber pigtails extending from the edges of substrate 100 and the input and output optical fibers. The fiber pigtails rest in these indentations.

Referring to FIGS. 5A and 5B, the lid 520 is made from the same material as the bottom portion of the housing and has corresponding indentations for the optical fibers and fiber pigtails. Lid 520 mates with the bottom portion 400, and the entire housing is sealed using conventional techniques such as gluing, etc. to create a housing around the substrate 100.

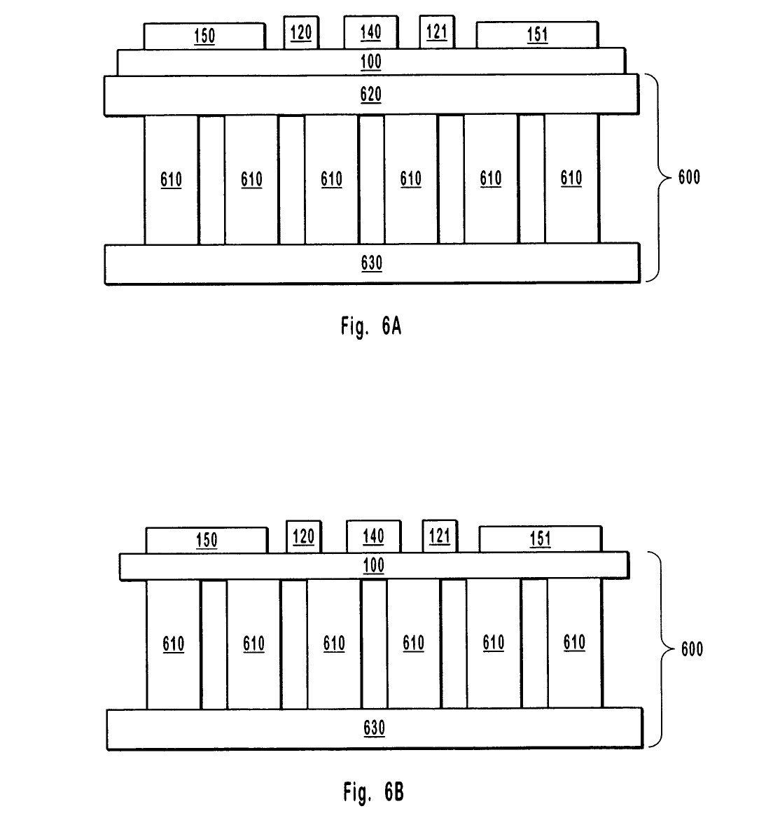

As mentioned previously, the SOA 230 may require a heat sink to properly dissipate heat produced by the SOA 230. In one approach, the heat generated by SOA 230 is dissipated via a thermal path that runs through the substrate 100 (i.e., through submount 220, spacer block 210, and substrate 100) to a heat sink. One heat sink that is commonly used is a thermo-electric or peltier cooler. FIG. 6A is an illustration of a peltier cooler 600 with substrate 100 mounted to a cool plate 620 of peltier cooler 600. Peltier coolers include semiconductor elements 610 which are connected in series between two ceramic plates 620 and 630. Peltier coolers work by passing current through the peltier cooler which draws heat from one of the ceramic plates (referred to as the cool plate 620) to the other (referred to as the warm plate 630).

In another embodiment, illustrated in FIG. 6B, substrate 100 replaces cool plate 620 of peltier cooler 600. In this embodiment, substrate 100 is a ceramic substrate that functions as the cool plate of the peltier cooler and a mounting platform for SOA 230. This embodiment of the invention further reduces the size of the overall package by eliminating a ceramic plate. In another embodiment, the warm plate 630 of the peltier cooler also serves as an overall mounting plate for the entire packaged device.

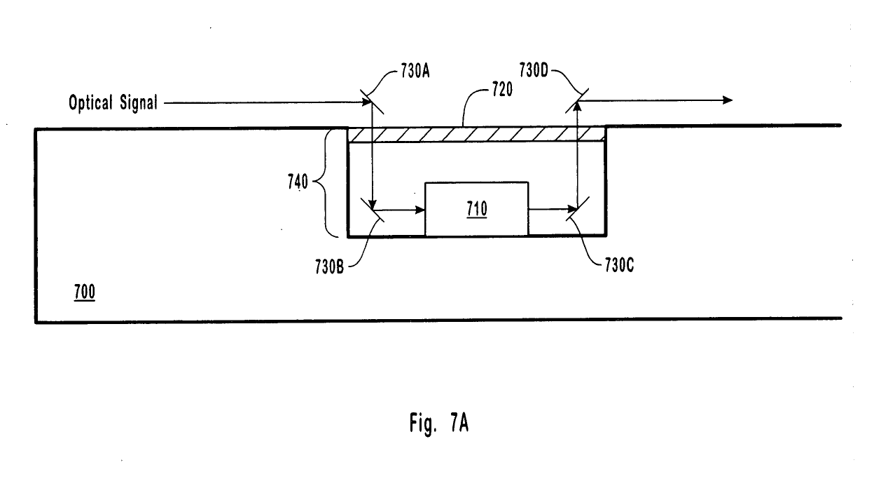

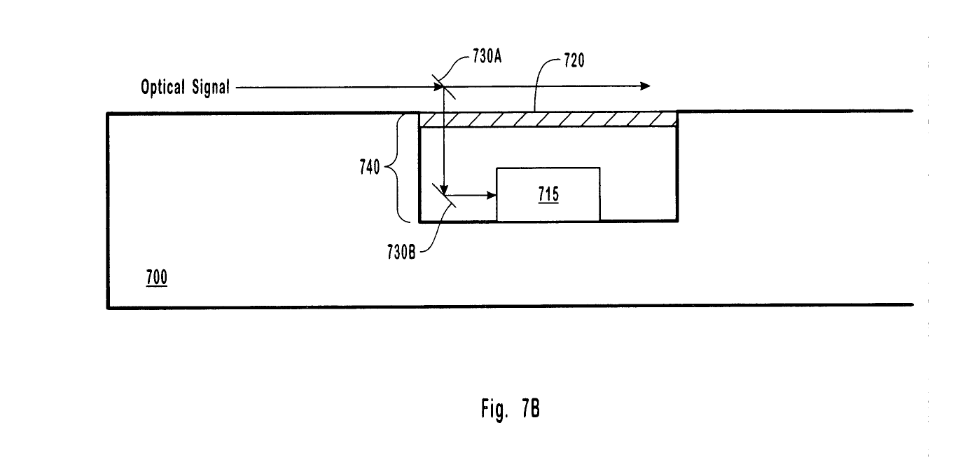

FIG. 7A illustrates another embodiment of the invention, wherein substrate 700 has a recessed area 740 and a two port optical device positioned in recessed area 740. In one embodiment, an optical device such as a semiconductor optical amplifier (SOA) 710 is positioned in recessed area 740 and hermetically sealed using a window 720. The window is transparent to allow an optical signal to pass to the semiconductor optical amplifier 710. Window 720 can be made from various transparent materials.

A means for redirecting an optical signal between an optical path located along the top surface of substrate 700 and the optical device mounted in recessed area 740 is also provided. For example, reflective devices such as mirrors 730A-730D are positioned inside and outside of recessed area 740 to direct an optical signal propagating above substrate 700 into recessed area 740. In this embodiment, the optical signal is reflected by mirror 730A through window 720 into recessed area 740. Mirror 730B reflects the optical signal from mirror 730A into semiconductor optical amplifier 710. The output of semiconductor optical amplifier 710 is reflected out of recessed area 740 by mirror 730C through window 720. Mirror 730D then reflects the optical signal so that it once again propagates above substrate 700. Non-reflective devices can also be used to redirect light from the optical path along the top surface of substrate 700 into recessed area 740. For example, refractive devices (e.g., prisms), diffractive devices (e.g., gratings), waveguides and/or couplers (e.g. coupling energy from a waveguide on the surface to a waveguide in recessed area 740), or combinations thereof, can be used for this purpose.

In another embodiment of the invention illustrated in FIG. 7B, a one port optical device, such as a photodetector 715, is positioned in a recessed area 740 of a substrate 700. In this embodiment, mirror 730A is used as a tap to redirect a portion of the optical signal to photodetector 715 in recessed area 740 of substrate 700. The majority of the optical signal passes through mirror 730A and continues along its original optical path. In this embodiment, photodetector 715 detects and monitors the signal strength of optical signals as they propagate along substrate 700. Again, window 720 can be placed over the opening of recessed area 740 to create a hermetic seal around photodetector 715.

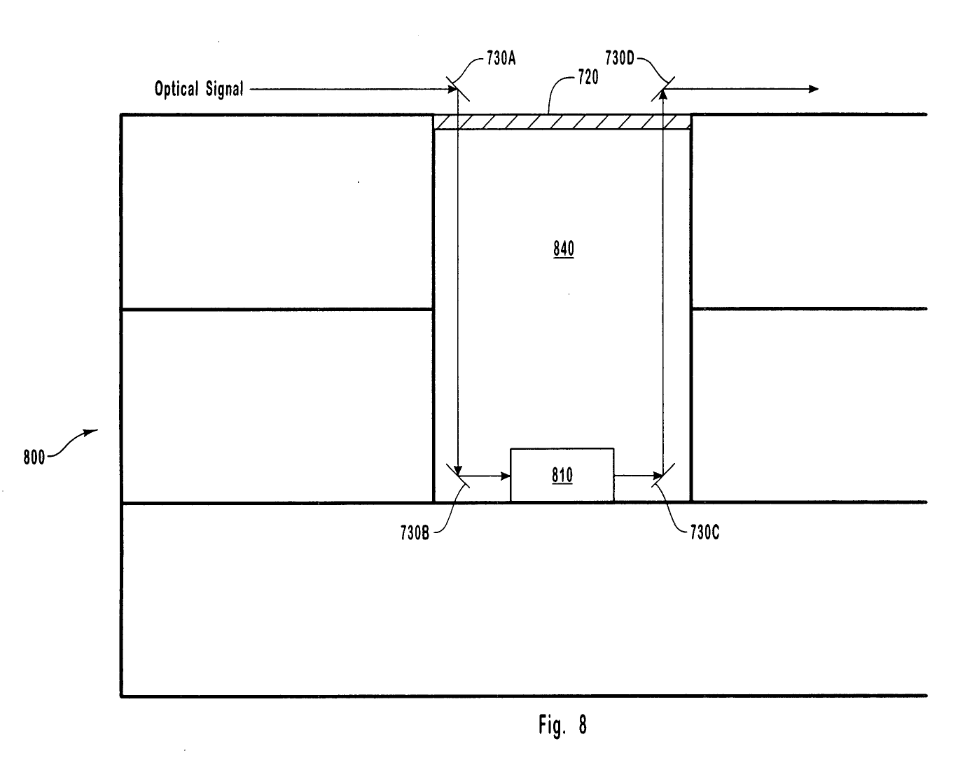

In another embodiment of the present invention, optical devices are positioned in recessed areas of multi-layer substrates. FIG. 8 illustrates a two-port optical device 810 recessed in a multi-layer substrate 800. A recessed area 840 extends into two layers of the multi-layer substrate 800. The layers have holes that form the recessed area 840. The present invention is not limited to the embodiment described above. For example, substrate 800 can be any number of layers and the recessed area can extend into any number of layers of the multi-layer substrate. Mirrors 730A-730D are positioned inside and outside of recessed area 840 to direct an optical signal propagating above substrate 800 into recessed area 840. In this embodiment, the optical signal is reflected by mirror 730A through window 720 into recessed area 840. Mirror 730B reflects the optical signal from mirror 730A into semiconductor optical amplifier 810. The output of semiconductor optical amplifier 810 is reflected out of recessed area 840 by mirror 730C through window 720. Mirror 730D then reflects the optical signal so that it once again propagates above substrate 800.

The above description is included to illustrate various embodiments of the present invention and is not meant to limit the scope of the invention. For example, although much of the above text describes packaging a semiconductor optical amplifier, other electro-optic devices can be packaged according to the present invention.

In addition, the cap may be used to hermetically seal more than one device at a time. For example, an application may require the use of two or more semiconductor optical amplifiers in series. The amplifiers may be mounted on a common substrate (or otherwise rigidly positioned relative to each other) and a single cap used to hermetically seal some or all of the amplifiers. Similarly, a single cap may also seal combinations of laser source and amplifier, or amplifier and photodetector.

Depending on the configuration of devices within the cap, the placement of the windows on the cap may also vary. It is not required that there be exactly two windows or that they be located across from each other, as shown in FIG. 2.

The specific approaches for mounting and aligning components in the overall package may also vary. In the example of FIG. 1, the fiber pigtails 150-151, lenses 120-121 and electro-optic device are all mounted using mounting plates. In addition, FIG. 2 illustrates a specific approach to mounting the electro-optic device 230 to the substrate 100, using a submount 220, spacer block 210, plate 330, and mounting plate 215. None of the foregoing is required. Other designs and techniques may be used.

As a final example, the invention is also not limited to the specific approaches used to route optical and/or electrical signals. For example, devices other than fiber pigtails and discrete lenses can be used as the inputs and outputs to the final package. Some examples include GRIN lenses, lens arrays, waveguides, and free space propagation. Electrical routing can be achieved by using multiple conducting layers (e.g., multiple metal layers), multi-layer substrates, or other conventional techniques.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An optical package, comprising:
a substrate;
an optical device supported at least indirectly by the substrate; and
a window covering a portion of the substrate that at least indirectly supports the optical device, the window forming a hermetic seal for the optical device.

2. The optical package as recited in claim 1, wherein the substrate defines a recessed area wherein the optical device is mounted.

3. The optical package as recited in claim 1, wherein the optical device comprises a semiconductor optical amplifier (SOA).

4. The optical package as recited in claim 1, wherein the optical device comprises a photodetector.

5. The optical package as recited in claim 1, wherein the optical device comprises a single port device.

6. The optical package as, recited in claim 1, wherein the optical device comprises a two port device.

7. The optical package as recited in claim 1, wherein the substrate comprises a plurality of layers.

8. The optical package as recited in claim 1, further comprising a means for redirecting an optical signal, the means for redirecting an optical signal serving to redirect an optical signal such that the redirected signal passes through the window and into the optical device.

9. The optical package as recited in claim 8, wherein the means for redirecting an optical signal comprises a plurality of reflective devices.

10. The optical package as recited in claim 9, wherein at least one of the plurality of reflective devices is hermetically sealed by the window.

11. The optical package as recited in claim 8, wherein the means for redirecting an optical signal comprises a plurality of substantially non-reflective devices.

12. The optical package as recited in claim 1, further comprising a plurality of optical components collectively configured and arranged to tap a portion of a light signal and to direct the tapped portion of the light signal to the optical device.

13. The optical package as recited in claim 12, wherein one of the plurality of optical components is hermetically sealed by the window.

14. The optical package as recited in claim 1, further comprising:
a first reflective device arranged to redirect light from a first optical path to an area hermetically sealed by the window;
a second reflective device hermetically sealed by the window and arranged to redirect light received from the first reflective device to an optical input of the optical device;
a third reflective device hermetically sealed by the window and arranged to redirect light received from an output of the optical device; and
a fourth reflective device arranged to receive light from the output of the optical device and to reflect the received light along a second optical path.

15. An optical package, comprising:
a substrate that defines a recess;
an optical device substantially disposed within the recess;
a window disposed so as to hermetically seal the optical device within the recess; and
first and second optical components, the first optical component arranged to redirect a portion of an optical signal, and the second optical component arranged to receive the redirected portion of the optical signal and to reflect the received signal into the optical device.

16. The optical package as recited in claim 15, wherein the optical device comprises a semiconductor optical amplifier (SOA).

17. The optical package as recited in claim 15, wherein the optical device comprises a photodetector.

18. The optical package as recited in claim 15, wherein the first and second optical components are reflective.

19. The optical package as recited in claim 15, wherein the first and second optical components are substantially non-reflective.

20. The optical package as recited in claim 15, wherein at least one of the first and second optical components is hermetically sealed by the window.

21. The optical package as recited in claim 15, wherein the substrate comprises a plurality of layers, at least one of which is penetrated by the recess.

22. The optical package as recited in claim 15, wherein the first and second optical components collectively comprise an optical tap.

23. The optical package as recited in claim 15, further comprising:
a third optical component arranged to receive and redirect a signal from the optical device; and
a fourth optical component arranged to receive and redirect the signal from the third optical component.

24. The optical package as recited in claim 23, wherein at least one of the first, second, third and fourth optical components is hermetically sealed by the window.

25. The optical package as recited in claim 23, wherein at least one of the first, second, third and fourth optical components is reflective.
